(19) United States
(12) Patent Application Publication
(10) Pub. No.: US 2015/0131805 A1
(43) Pub. Date: May 14, 2015

(54) AUDIO SIGNAL PROCESSING DEVICE, STORAGE MEDIUM AND AUDIO SIGNAL PROCESSING METHOD

(71) Applicant: Yamaha Corporation, Hamamatsu-Shi (JP)

(72) Inventors: Akihiro MIWA, Hamamatsu-shi (JP); Takurou SONE, Hamamatsu-shi (JP)

(21) Appl. No.: 14/599,065

(22) Filed: Jan. 16, 2015

Related U.S. Application Data
(63) Continuation of application No. PCT/JP2013/068754, filed on Jul. 9, 2013.

(30) Foreign Application Priority Data
Jul. 17, 2012 (JP) 2012-158670

(51) Int. Cl. H04R 29/00

(52) U.S. Cl. CPC H04R 29/00
USPC 381/56

(57) ABSTRACT

Respective signal processing modules are executed in a DSP of an audio signal processing device, and also a signal abnormality detecting module is executed. The signal abnormality detecting module executes processing to detect a clip at metering points set at input and output ends of respective signal processing modules, and store in the storage an audio signal in which the clip is detected while correlating with the measuring points the metering point at which the clip is detected. The audio signal stored in the storage is outputted by the output module.

### TECHNICAL FIELD

Technology disclosed in the present application relates to an audio signal processing device which mixes audio signals, a storage medium, and a processing method of an audio signal.

### BACKGROUND ART

Conventionally, in an audio signal processing device (for example, an audio mixer) which performs signal processing such as mixing, equalizing, filtering, and the like on an audio signal, a clip occurs due to limitation of an instantaneous value of an outputted audio signal when the level of a signal is excessive.

Among audio signal processing devices of this kind, as described in PTL1 for example, there is one which sets measuring points (metering points in the literature) at input and output ends of signal processing modules which perform various types of signal processing, and measures a signal level at each measuring point to detect the clip. Further, as described in PTL2 for example, there is one which displays a signal processing system as a block diagram on a display unit, switches a display of a measuring point where the clip is detected on the block diagram, and automatically displays on the display unit a characteristic setting screen (rotary encoder or the like) related to the signal processing module where the clip has occurred.

### CITATION LIST

### Patent Literature

{PTL1} JP 3705128 B2

{PTL2} JP 4265339 B2

### SUMMARY OF INVENTION

### Technical Problem

However, in an audio signal processing device which detects an abnormality (excessive input, or the like) of audio signal like the above-described clip, it is possible to recognize an occurrence of abnormality of signal or recognize a module in which the abnormality has occurred, but it is difficult to actually recognize what kind of signal is detected as abnormal. On the other hand, there are cases where it is desired to analyze the causes later and address them, such as the case where a desired operation is not realized after performing a setting change with respect to the occurrence of an abnormal signal, and there are demands for recognizing an audio signal detected as abnormal.

The technology disclosed in the present application has been proposed in view of the above-described problems. It is an object thereof to provide an audio signal processing device, a program and a processing method of an audio signal which is capable of detecting and storing an abnormality of audio signal.

### Solution to Problem

An audio signal processing device according to the technique disclosed in the present application includes a signal processor, a signal abnormality detector, and an outputter. The signal processor performs signal processing on an audio signal. The signal abnormality detector detects an abnormality of the audio signal at measuring points set with respect to the signal processor, and stores in a storage the audio signal in which the abnormality is detected while correlating with the measuring points. The outputter configured to output the audio signal correlated with the measuring points and stored in the storage.

Further, an audio signal processing device according to the technique disclosed in the present application is such that, in the above audio signal processing device, the signal abnormality detector stores in the storage, together with the audio signal in which the abnormality is detected, at least one of the audio signal before the abnormality is detected and the audio signal after the abnormality is no longer detected.

Further, an audio signal processing device according to the technique disclosed in the present application is such that, in any of the above audio signal processing device, the signal abnormality detector stores, in the storage, also information related to the signal processor to which the measuring point where the abnormality of audio signal is detected is set, and the outputter outputs the information together with the stored audio signal or individually.

Further, an audio signal processing device according to the technique disclosed in the present application further includes, in any of the above audio signal processing device, a display controller configured to control a display to display information indicating plural audio signals stored corresponding to the measuring points, a selector configured to select the audio signal to be outputted by the outputter from among the displayed audio signals.

Further, an audio signal processing device according to the technique disclosed in the present application is such that, in any of the above audio signal processing device, when the abnormality of audio signal is detected, the signal abnormality detector stores in the storage the audio signals at all the measuring points including the measuring point where the abnormality of audio signal is detected.

Further, an audio signal processing device according to the technique disclosed in the present application is such that, in any of the above audio signal processing device, when the abnormality of audio signal is detected, the signal abnormality detector stores in the storage the audio signals at the measuring point where the abnormality of audio signal is detected and at the measuring point located upstream of the measuring point where the abnormality of audio signal is detected along a signal processing path through which the audio signal is transmitted, among the measuring points.

A storage medium according to the technique disclosed in the present application is a non-transitory machine-readable storage medium containing a program to be applied to an audio signal processing device processing an audio signal, the program enabling the device to execute: detecting an abnormality of the audio signal at measuring points set with respect to a signal processor performing signal processing on the audio signal, and storing in a storage the audio signal in which the abnormality is detected while correlating with the measuring points; and outputting the audio signal correlated with the measuring points and stored in the storage.

An audio signal processing method according to the technique disclosed in the present application includes detecting an abnormality of the audio signal at measuring points set with respect to a signal processor performing signal processing on the audio signal; and storing in a storage the audio signal in which the abnormality is detected while correlating with the measuring points.

Further, an audio signal processing method according to the technique disclosed in the present application is such that, in the above audio signal processing method, in the storing, the audio signals at all the measuring points including the measuring point where the abnormality of audio signal is detected are stored in the storage.

Further, an audio signal processing method according to the technique disclosed in the present application is such that, in the above audio signal processing method, in the storing, the audio signals at the measuring point where the abnormality of audio signal is detected and at the measuring point located upstream of the measuring point where the abnormality of audio signal is detected along a signal processing path through which the audio signal is transmitted, among the measuring points, are stored in the storage.

### Advantageous Effects of Invention

The technology disclosed in the present application can provide an audio signal processing device, a program and a processing method of an audio signal which is capable of detecting and storing an abnormality of audio signal.

### BRIEF DESCRIPTION OF DRAWINGS

FIG. 1 is a block diagram illustrating an audio signal processing device of an embodiment.

FIG. 2 is a block diagram for explaining processing of detecting an abnormality of audio signal.

FIG. 3 is a diagram for explaining a data format of an audio buffer.

FIG. 4 is a diagram illustrating a screen of a display unit.

FIG. 5 is a diagram illustrating a screen of the display unit.

FIG. 6 is a diagram for explaining an occurrence timing of a clip.

FIG. 7 is a flowchart illustrating processing of a signal abnormality detecting module.

FIG. 8 is a diagram for explaining a data format of an audio signal stored in a storage.

FIG. 9 is a block diagram for explaining processing for detecting an abnormality of audio signal in another example.

FIG. 10 is a flowchart illustrating processing of the signal abnormality detecting module in another example.

### DESCRIPTION OF EMBODIMENTS

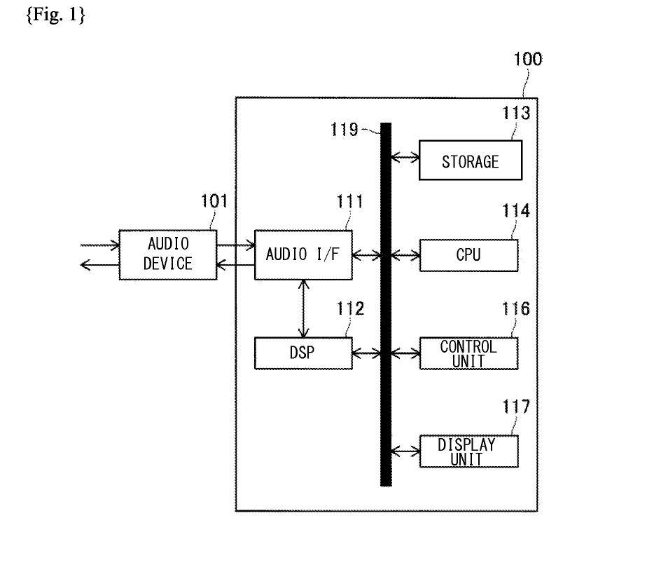

FIG. 1 is a block diagram illustrating an audio signal processing device 100 according to an embodiment of the present application. This audio signal processing device 100 is a device performing various types of signal processing on an audio signal inputted from an audio device 101 for example, and outputs an audio signal after being processed to the audio device 101.

The audio device 101 has, for example, an input unit which inputs an analog audio signal from an external device (such as a microphone), and A/D converts and outputs the audio signal to the audio signal processing device 100, and an output unit which inputs a digital audio signal from the audio signal processing device 100, and D/A converts and outputs the audio signal to an external device (an amplifier, a speaker, or the like).

The audio signal processing device 100 has an audio interface (audio I/F) 111, a DSP 112, a storage 113, a CPU 114, a control unit 116, and a display unit 117, and these circuits are connected via a system bus 119. The audio I/F 111 is connected to the audio device 101 via a coaxial cable for example. The audio I/F 111 outputs a digital audio signal inputted from the input unit of the audio device 101 to the DSP 112. Note that the audio I/F 111 may be configured to output the digital audio signal to the system bus 119. Further, besides a terminal connected to the audio device 101, although not illustrated, the audio I/F 111 may have terminals for connecting other devices such as an electronic musical instrument, and may input or output an audio signal also from these terminals.

The DSP 112 is a digital signal processor, and inputs a digital audio signal outputted by the audio I/F 111 and performs various kinds of signal processing on the digital audio signal. This signal processing includes, for example, mixing, equalizing, filtering, and the like. The DSP 112 realizes the signal processing by executing a program (hereinafter referred to as a “signal processing module”) according to the processing to be performed. The DSP 112 outputs the digital audio signal on which the signal processing is performed to the output unit of the audio device 101 via the system bus 119 or the audio I/F 111.

The storage 113 has a volatile memory such as a RAM and a non-volatile memory such as a hard disk. The DSP 112 loads, for example, a signal processing module stored in the hard disk of the storage 113 to the memory of the storage 113 and executes it. Then, the DSP 112 executes each signal processing module and executes a signal abnormality detecting module in parallel. This signal abnormality detecting module executes processing to detect an abnormality in a digital audio signal processed in each signal processing module, and store in the storage 113 the audio signal in which the abnormality is detected. Further, the signal abnormality detecting module executes processing to store in the storage 113 information or the like related to the signal processing module in which the abnormality of audio signal is detected by correlating the information with the audio signal in which the abnormality is detected.

The CPU 114 is a control device which controls the entire operation of the audio signal processing device 100. The CPU 114 performs control based on a control program stored in the storage 113. The CPU 114 displays, for example, information stored in the storage 113 by the signal abnormality detecting module on the display unit 117 (LCD for example).

The control unit 116 includes various controls (faders, control buttons, a keyboard, a pointing device, a mouse, and the like) which is operated by a user such as a mixing technician. The CPU 114 sets and changes control parameters used for various programs of signal processing modules executed in the DSP 112 based on control information from the user with respect to the control unit 116. Further, the CPU 114 obtains various data (setting information, level value, and so on) from the DSP 112 and displays the data on the display unit 117.

In the audio signal processing device 100 having such a configuration, the user can control a mode of signal processing in the DSP 112 by performing an operation on the control unit 116 while checking displayed data and the like on the display unit 117. Then, in the audio signal processing device 100, an abnormality of audio signal (clip for example) inputted and signal processed is detected by the signal abnormality detecting module, and an audio signal in which an abnormality is detected is stored in the storage 113. Thus, the user can check the audio signal in which the abnormality is detected, at any moment after detection of the abnormality.

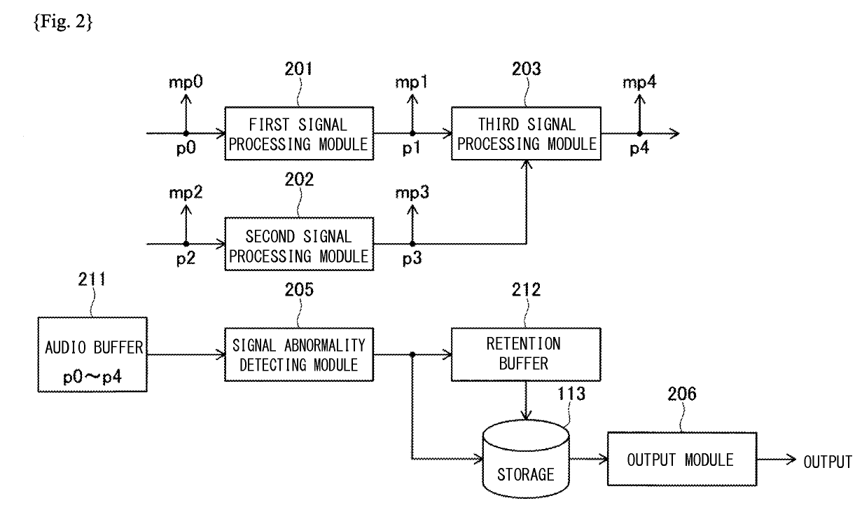

Next, an example of the signal processing in the DSP 112 illustrated in FIG. 1 will be described using FIG. 2. First to third signal processing modules (hereinafter referred to as “first to third modules”) 201 to 203 illustrated in FIG. 2 are examples of the above-described signal processing modules, in which the third module 203 performs processing to mix audio signals processed respectively by the first and second modules 201, 202 and output the mixed audio signal. Note that each module 201 to 203 is realized by a microprogram executed by the DSP 112 and is executed repeatedly in, for example, every unit of transmission of audio signal (1 frame).

The first and second modules 201, 202 execute, for example, processing to respectively input digital audio signals inputted to plural channels (two channels in this case) from the audio device 101, perform adjusting characteristics (such as filtering and equalizing), adjusting signal levels, and the like on the respective audio signals and output the adjusted audio signals. Setting related to this characteristic adjustment and the like is set by changing control parameters of the modules 201 to 203 based on an operation on the control unit 116 by the user. Further, the third module 203 executes, for example, processing to mix digital audio signals of plural channels (in this case, two channels outputted by the first and second modules 201, 202, respectively), perform adjusting characteristics, signal levels, and the like on the mixed audio signal and output the adjusted audio signal.

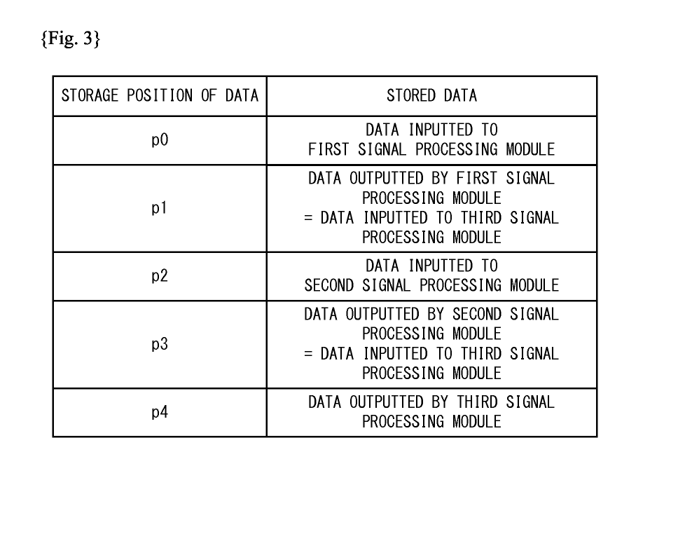

Further, in the storage 113, a buffer area (hereinafter referred to as an “audio buffer”) 211 is secured, which temporarily stores audio signals on which the modules 201 to 203 perform signal processing. FIG. 3 illustrates an example of a data format of the audio buffer 211. The audio buffer 211 stores data inputted to or outputted by the modules 201 to 203 in buffer areas illustrated by respective points (addresses) p0 to p4. In each buffer area, for example, an audio signal of for 10 milliseconds is stored in a predetermined data format. For example, in the buffer area indicated by the point p0, an audio signal to be inputted to the first module 201 is stored.

Here, while executing the first to third modules 201 to 203, the DSP 112 executes in parallel a signal abnormality detecting module (hereinafter referred to as a “detecting module”) 205 detecting an abnormality in signals at measuring points (hereinafter referred to as “metering points”) set to each module 201 to 203. Note that processing of the detecting module 205 is executed, for example, after the processing of each module 201 to 203 is executed in the DSP 112.

As illustrated in FIG. 2, metering points mp0 to mp4 are respectively set at input and output ends of the modules 201 to 203. The metering points mp0 and mp2 are set corresponding to an external signal source (audio device 101 or another externally connected audio device, or the like). Further, the metering point mp1 is set corresponding to an output signal of the first module 201, the metering point mp3 is set corresponding to an output signal of the second module 202, and the metering point mp4 is set corresponding to an output signal of the third module 203. That is, in this embodiment, the metering points mp0 to mp4 are correlated with the signal processing modules 201 to 203 located in their respective preceding stages, or the signal sources.

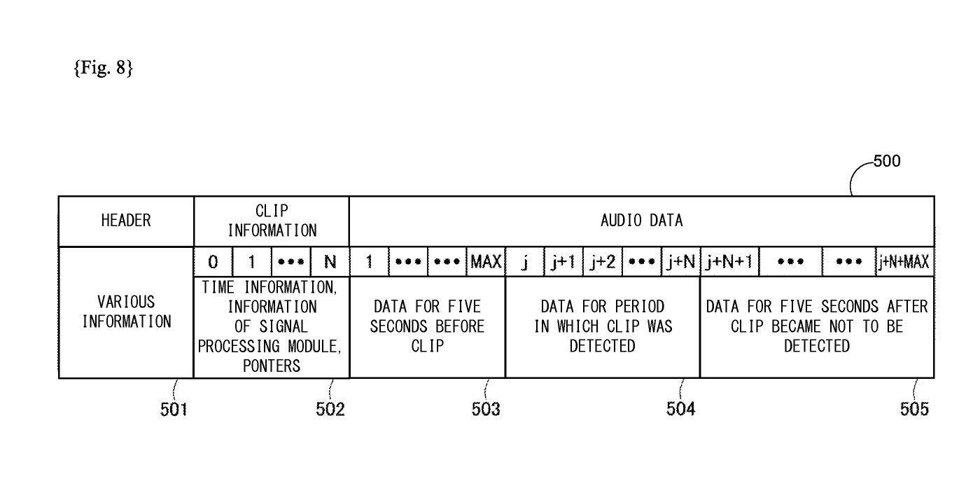

The points p0 to p4 of the audio buffer 211 illustrated in FIG. 3 correspond to the metering points mp0 to mp4, respectively. When executed, the detecting module 205 obtains (copies) data of the audio buffer 211. For example, the detecting module 205 obtains data corresponding to the metering point mp0 from the buffer area indicated by the point p0. Then, the detecting module 205 executes processing to detect, for example, a clip as the abnormality of audio signal by measuring signal levels of the respective audio signals at the metering points mp0 to mp4, or the like. When the abnormality of audio signal is detected, the detecting module 205 executes processing to store data including the audio signal at a time of occurrence of abnormality in the storage 113. Further, the detecting module 205 executes processing to store the audio signal to be stored in the storage 113 together with other related information (see FIG. 8). Note that when the abnormality of audio signal is detected, the detecting module 205 of this embodiment executes processing to store the audio signals at all the metering points mp0 to mp4 in the storage 113.

Note that the abnormality of audio signal mentioned here is not limited to the excessive input of a signal such as a clip state, and includes other changes in signal state, for example a howl, a noise generated when a connection terminal is pulled off by an erroneous operation by the user, resulting in no input, or also the cases where a signal level detected at the metering points mp0 to mp4 is less than or equal to a predetermined value (no input, or the like), and the like. Further, the abnormality of audio signal also includes a state in which lack of data has occurred, for example, a state in which missing bits occurred in part of frame data due to a transmission error, or a state in which missing bits in frame data are supplemented, when the audio signal is transmitted through a signal processing path in frame units between the audio signal processing device 100 and the audio device 101 or among the signal processing modules in the audio signal processing device 100. Detection of such an abnormality of audio signal may be performed according to, for example, a predetermined algorithm using a set threshold or the like based on a signal as a detection target, and it is preferred that this algorithm (threshold or the like) can be set and changed by the user by operating the display unit 117 corresponding to an abnormal state to be detected. In the following description, the case where the abnormality of audio signal is a clip state will be mainly explained.

The detecting module 205 secures an area of a retention buffer 212 for temporarily storing audio signals in the storage 113. The detecting module 205 stores, for example, audio signals for five seconds in the retention buffer 212. Further, the detecting module 205 updates the retention buffer 212 and meanwhile obtains audio signals from the audio buffer 211 and the retention buffer 212 and stores them in the storage 113 when the abnormality of audio signal is detected. The audio signals stored in the storage 113 are outputted by an output module 206.

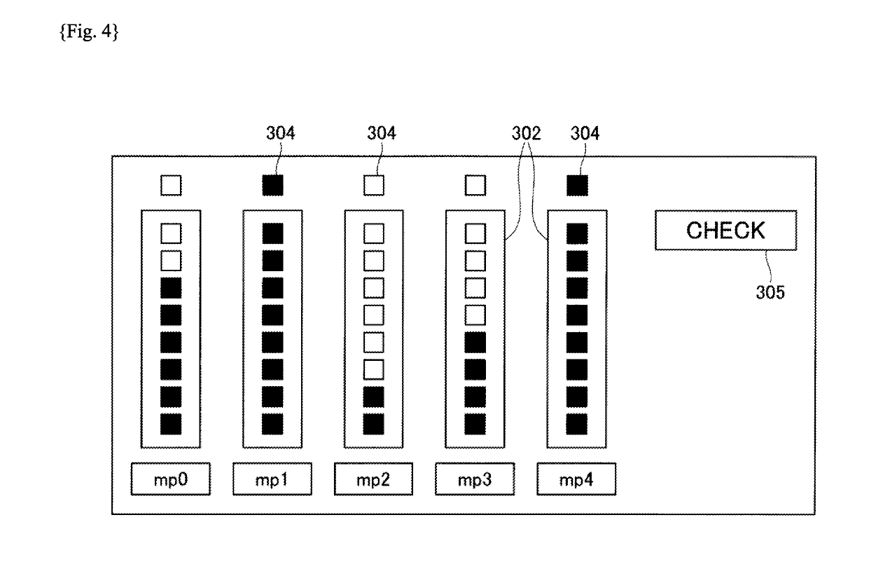

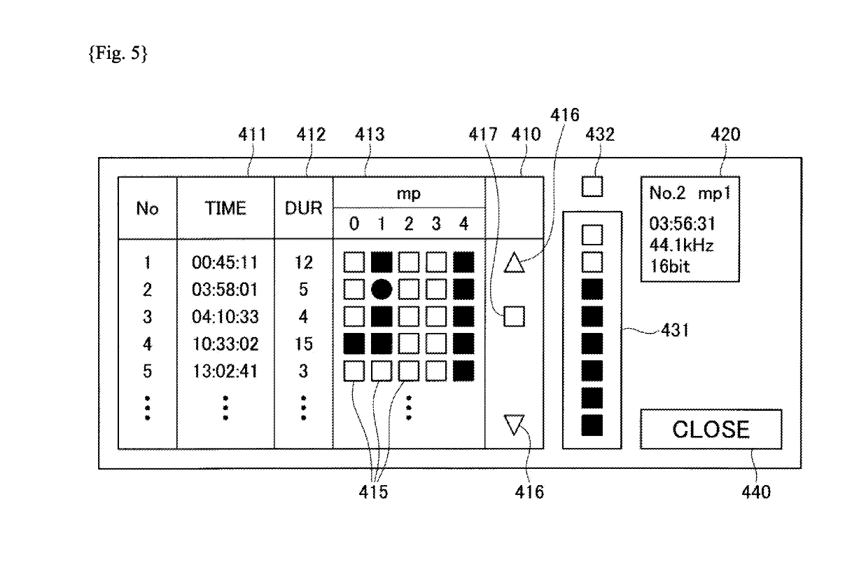

The output module 206 is executed by the CPU 114, executes processing to read the stored audio signals from the storage 113 in response to detection of the abnormality in an audio signal, and output the audio signals to, for example, the audio device 101. Further, the output module 206 reads information related to the outputted audio signals from the storage 113 and displays the information on the display unit 117 (see FIG. 5). At the same time, the output module 206 displays the signal levels and clip states at the metering points mp0 to mp4 temporarily stored in the audio buffer 211 on the display unit 117 (see FIG. 4).

FIG. 4 is an example of a screen displayed on the display unit 117 by the output module 206. As illustrated in FIG. 4, on the screen of the display unit 117, level meters 302 are displayed, in which signal levels corresponding to the metering points mp0 to mp4 are displayed in a bar graph form. Above each level meter 302, a clip display portion 304 is displayed, which lights up when the abnormality of audio signal (clip) occurs at each metering point mp0 to mp4.

Further, on the right side of the level meters 302, displayed is a switch button (“CHECK” in the diagram) 305 for instructing to display a screen enabling to check an audio signal stored in response to detection of the abnormality of audio signal or the related information. The switch button 305 is activated and becomes selectable when the abnormality of audio signal occurs at one of the metering points mp0 to mp4. For example, on the screen display illustrated in FIG. 4, the clip display portions 304 corresponding to the metering points mp1 and mp4 are lighted, indicating that the abnormality of audio signal (clip) has occurred at the metering points mp1 and mp4. In this state, the screen illustrated in FIG. 5 is displayed on the display unit 117 when, for example, the user operates the switch button 305 with the mouse of the control unit 116. Note that the detecting module 205 may be configured to detect an abnormality (howl, or the like) of audio signal other than the clip, and store data including an audio signal of the detected howl in the storage 113. In this case, the output module 206 may be configured to light up the clip display portions 304 of the metering point mp0 to mp4 where the howl has occurred, and activate the switch button 305 in response to the occurrence of the howl. Further, the detecting module 205 may be configured to execute plural modules respectively corresponding to types of abnormality of audio signal in parallel on the DSP 112.

FIG. 5 is an example of a screen displayed in response to an operation of the switch button 305 of FIG. 4. As illustrated in FIG. 5, on the screen of the display unit 117, a list display section 410 is displayed in a center part of the left side. In the list display section 410, information related to the abnormality of audio signal is displayed row by row in the order of time of storing (order of 1, 2, 3 . . . in the field of No. in the diagram). In each row of the list display section 410, a time display field 411, a duration display field 412, and a point selection field 413 are displayed. In the time display field 411, the time when the abnormality of audio signal has occurred is displayed. In the duration display field 412, the time period in which the abnormality of audio signal occurred continuously is displayed.

In the point selection field 413, buttons 415 corresponding to the respective metering points mp0 to mp4 are displayed. The notation of the buttons 415 (square “□” in the diagram) in FIG. 5 is such that each outlined square display indicates that the abnormality of audio signal is not detected (that is, a normal state) and each black square display indicates that the abnormality of audio signal is detected. For example, on the display screen illustrated in FIG. 5, display of the first row (No. 1) indicates that “a clip occurred for twelve seconds from time 00:45:11, and the abnormality (clip) of audio signal is detected at metering points mp1 and mp4.”

When operating information of any button 415 (outlined square “□” or black square “▪”) of the point selection field 413 operated by the user is inputted, the output module 206 executes processing to output record data regarding the corresponding metering point mp0 to mp4 from the audio device 101. Further, the output module 206 executes processing to change display of the button 415 operated by the user to a black circle “” illustrated in FIG. 5. The black circle “” indicates that the relevant metering point is selected, and the stored audio signal is being outputted. Further, the output module 206 executes processing to restore the display of the button 415 to its original state (outlined “□” or black “▪”) when the output of the record data ends. Further, the detecting module 205 of this embodiment stores in the storage 113 the audio signals of all the metering points mp0 to mp4 at a time of abnormality of audio signal. Therefore, when the abnormality of audio signal has occurred at any one of the metering points mp0 to mp4, the storage 113 stores also the audio signals of the other metering points mp0 to mp4. Note that the output module 206 executes processing to scroll the screen display according to operating information of a scroll button 416 or a scroll bar 417 operated, which are provided on the right side of the point selection field 413, thereby displaying on the list display section 410 a part not displayed due to insufficiency of displayed rows.

On the right side of the list display section 410, an information display section 420, a level meter 431, and a clip display portion 432 are displayed. The information display section 420 displays information related to record data being reproduced (for example, metering point, time during reproduction, sample frequency of audio signal, and quantifying bit number), which are selected in the point selection field 413. For example, the screen display illustrated in FIG. 5 indicates that “an audio signal of No. 2 corresponding to at the time of the clip occurred for five seconds from time 03:58:01 at the metering point mp1 is being reproduced, and the current reproduction time of the data is 1.5 seconds before the clip occurred (03:56:31).” On the level meter 431 and the clip display portion 432, the signal level and the abnormal state of audio signal (state of clip) in the record data being reproduced are displayed. Note that the output module 206 executes processing to restore the display unit 117 to the screen display of FIG. 4 when an end button 440 is operated by the user.

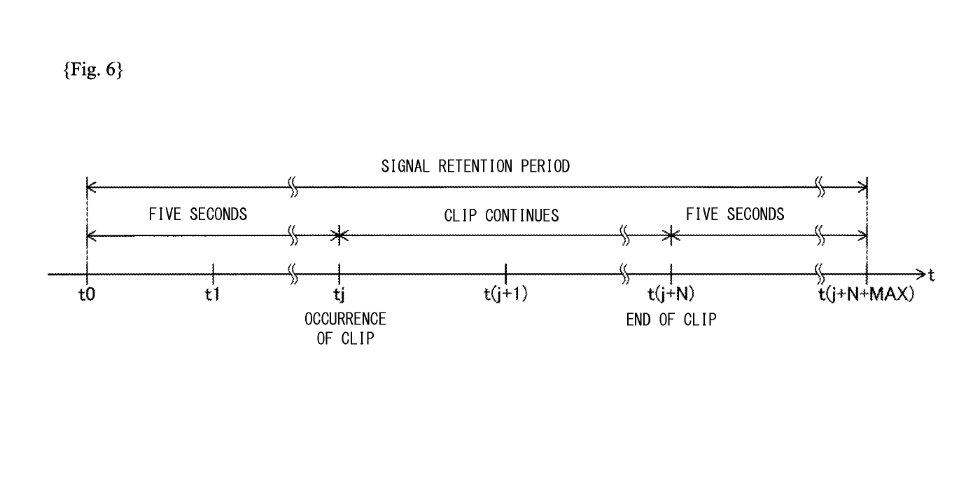

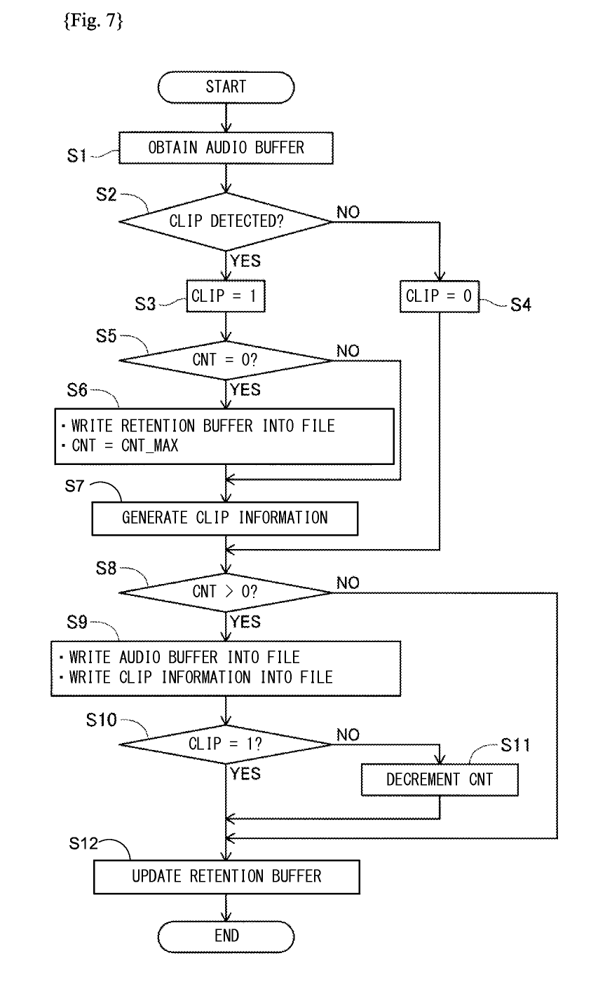

Next, a processing procedure of the detecting module 205 illustrated in FIG. 2 will be described using FIG. 6 and FIG. 7. In the following explanation, one cycle of executing the modules 201 to 203 is assumed as one sampling cycle (for example, a sampling frequency is set to 44.1 kHz), and the detecting module 205 is executed in every cycle. Further, in the following explanation, it is assumed that the clip is detected at the metering point mp1 at time tj as illustrated in FIG. 6, and thereafter the clip state continuously occurs N+1 times (N+1 cycles) and then ended at time t(j+N). This time ti (i=0, 1, 2, . . . , j, . . . , j+N) indicates a time in units of one cycle. Further, the detecting module 205 executes processing of a flowchart illustrated in FIG. 7 in every cycle.

(Time t0)

First, at time t0, the detecting module 205 obtains data (buffer areas of points p0 to p4) of the audio buffer 211 (see FIG. 2) corresponding to the respective metering points mp0 to mp4 (step S1 of FIG. 7). Next, the detecting module 205 executes detection processing on the data obtained in step S1 as to whether the clip has occurred or not (step S2). No clip has occurred at any of the metering points mp0 to mp4 at time t0. Thus a flag CLIP indicating the occurrence of a clip is set at “0” (no detection) (step S4), and a comparison is performed on whether or not a counter value CNT is larger than “0” (step S8).

Here, the detecting module 205 is set to execute the processing of storing the audio signal including a predetermined time (five seconds) before and after the clip occurred, and the value corresponding to output of an audio signal for five seconds is set to the counter value CNT in step S6. For example, when the sampling frequency is 44.1 kHz and the detecting module 205 is executed at every one sample cycle, a counter value CNT_MAX corresponding to the five seconds is “220500”. This predetermined time is preferred to be set appropriately according to characteristics of abnormal signal, and the like.

Note that the initial value of the counter value CNT is set to “0”, and the value of CNT is “0” at time t0. In this case, after the counter value CNT is compared in step S8, in step S12 the retention buffer 212 (see FIG. 2) is updated using the data of the audio buffer 211 obtained in step S1. Thus, the detecting module 205 continues to update the retention buffer 212 in every cycle during the period in which no clip is detected, so that the audio signal of most recent five seconds is always stored in the retention buffer 212.

(Time tj)

At time tj, the detecting module 205 detects a clip from the data of the metering point mp1 obtained from the audio buffer 211 (step S2: YES). The detecting module 205 sets “1” (detection) to the flag CLIP when the clip is detected (step S3), and executes comparison of the counter value CNT (step S5). Since the counter value CNT is “0” (initial value), the writing to the retention buffer 212 is executed (step S6). The retention buffer 212 stores data of most recent five seconds, and the detecting module 205 stores data of the retention buffer 212 (data for five seconds immediately before the clip is detected) as a file in the storage 113. Further, the detecting module 205 sets the above-described value of CNT_MAX to the counter value CNT.

FIG. 8 illustrates an example of a data format stored in the file stored in the storage 113. Data 500 include the audio signal (audio data in the diagram) for five seconds before and after the period in which the clip occurred. In a header area 501 of the data 500, various information related to the audio signal (for example, storage start time, bit rate, sampling frequency, quantifying bit number, number of channels, number of detections of the clip (value of N+1), file size, and so on) is stored.

A first data area 502 subsequent to the header area 501 stores clip information in every cycle (0 to N in the diagram). The clip information includes, for example, time information, information of signal processing modules, pointers, and so on. A second data area 503 subsequent to the first data area 502 stores the audio signal for five seconds (1 to MAX) immediately before the clip occurred. This value of MAX is the same value as the above-described “CNT_MAX”. A third data area 504 subsequent to the second data area 503 stores the audio signal for N+1 cycles in which the clip was detected. Data (j to j+N) in this third data area 504 correspond respectively to 0 to N of the first data area 502 (clip information), and pointers included in the clip information indicate storage positions of respective data (j to j+N). A fourth data area 505 subsequent to the third data area 504 stores the audio signal for five seconds (j+N+1 to j+N+MAX) immediately after the clip state ended.

In execution of step S6 described above, data of the retention buffer 212 are stored in the second data area 503 of FIG. 8. Next, in step S7, the detecting module 205 generates a corresponding clip information in the first data area 502. Since the counter value CNT is larger than “0” (CNT_MAX) (step S8), the detecting module 205 writes the data and clip information of the audio buffer 211 in the file of the storage 113 (step S9). Thus, the clip information at time tj is stored at the head of the first data area 502 of FIG. 8, and data of the audio buffer 211 at time tj are stored at the head of the third data area 504. Note that the information included in the header area 501 is appropriately changed and updated accompanying that the other data areas of the data 500 are updated. The flag CLIP is judged in step S10, and since the flag CLIP is “1” the retention buffer 212 is updated (step S12).

(Time t(j+N))

Next, when data of all the metering points mp0 to mp4 obtained from the audio buffer 211 at time t(j+N) in FIG. 6 are in a state of not being clipped, the detecting module 205 judges that no clip is detected in step S2, and sets “0” to the flag CLIP (step S4). Since the counter value CNT is CNT_MAX as before at this point, steps S9, S10 are executed.

In step S10, the flag CLIP is judged to be “0”, and the detecting module 205 starts decrement of the counter value CNT (processing to subtract the value of CNT) (step S11). Here, as described above, since the value equivalent to five seconds is set to this CNT_MAX, step S9 is executed for five seconds after the clip ends. Therefore, the detecting module 205 executes processing to sequentially add data of the audio buffer 211 to the fourth data area 505 illustrated in FIG. 8. In other words, “1” is set to the flag CLIP as long as the clip is detected (step S3), and step S11 (decrementing) is not executed because of the judgment of step S10. Thus, when the occurrence of the clip continues, the counter value CNT is not subtracted, and data of the third data area 504 of FIG. 8 are added in every cycle (up to N+1 times in this case).

Further, after the clip ends, step S7 is not executed, and thus writing of the clip information is not executed in step S9. Further, the latest data are stored constantly in the retention buffer 212 because step S12 is executed continuously irrespective of occurrence of the clip. Thus, the detecting module 205 executes the above-described processing repeatedly in every cycle, so as to store the audio signal in the file stored in the storage 113 in the data format illustrated in FIG. 8. Note that the detecting module 205 may be configured to individually execute the above-described processing for all the metering points mp0 to mp4 including the metering point mp1 where the clip is detected. Further, the data 500 may be stored in the file corresponding to the metering points mp0 to mp4, or the data regarding plural metering points may be stored in one file. In any case, the detecting module 205 stores the audio signals corresponding to the metering points mp0 to mp4 in the storage 113 in the data format illustrated in FIG. 8.

As described in detail above, in the audio signal processing device 100 of this embodiment, the modules 201 to 203 are executed in the DSP 112, and the signal abnormality detecting module 205 is executed in parallel. The detecting module 205 detects the abnormality of audio signal (clip, or the like) at the metering points mp0 to mp4 set at the input and output ends of the modules 201 to 203, and stores in the storage 113 the audio signal in which the abnormality is detected while correlating with the metering points mp0 to mp4. Data of the audio signal stored in this storage 113 are outputted from the audio device 101 by the output module 206 executed in the CPU 114, enabling the user to check them. In such a configuration, when the abnormality of audio signal occurs, the user is able to check later the audio signal detected as abnormal, and to analyze causes for the occurrence of abnormality to address it. Moreover, by storing the audio signal in which the abnormality is detected, anyone can check the audio signal in which the abnormality is detected. Even when the abnormality cannot be solved by an operation, for example changing setting of control parameters by the user, or the like, the abnormality can be addressed more appropriately by having a specialist check it.

Further, the detecting module 205 executes processing to store the audio signal including a predetermined time (for example, five seconds) before and after the abnormality of the audio signal occurred, together with the audio signal in the period in which the abnormality occurred. Thus, the user can judge causes for the abnormality in consideration of the audio signal before and after the abnormality occurred.

Further, in the point selection field 413 (see FIG. 5) of the display unit 117, the buttons 415 by which the audio signal to be reproduced can be selected are provided corresponding to the metering points mp0 to mp4, and by the user operating the buttons 415, the detected audio signal can be checked easily.

Further, the display unit 117 (see FIG. 4) is provided with the clip display portions 304 which light up when the abnormality of audio signal at the metering points mp0 to mp4 is detected (signal level is clipped), and the switch button 305 which are activated when the abnormality has occurred in an audio signal. With such a configuration, the user can check occurrence of the abnormality of audio signal according to the display of the clip display portions 304 and the switch button 305. That is, even the audio signal processing device 100 having plural channels, the user is able to easily recognize and quickly address occurrence of the abnormality of audio signal.

Further, as illustrated in FIG. 2, at the input ends of the first and second modules 201 and 202, the metering points mp0 and mp2 are set corresponding to external signal sources. With such a configuration, from a detection result of the abnormality of audio signal (clip or the like) at the metering points mp0 and mp2, the user can check whether the abnormality of the audio signal occurred inside the signal processing modules (modules 201 and 202) or an abnormal signal is inputted from an external signal source. Consequently, with respect to the audio signal processing device 100 to which plural signal processing modules are connected, the user can easily identify the signal processing module in which the abnormal signal occurred.

Further, the audio signal processing device 100 is presented as one example of an audio signal processing device, the first to third signal processing modules 201 to 203 as one example of a signal processor, the metering points mp0 to mp4 as one example of a measuring point, the storage 113 as one example of a storage, the signal abnormality detecting module 205 as one example of a signal abnormality detector, the output module 206 as one example of a outputter, the display unit 117 as one example of a display, and the buttons 415 as one example of a selector.

Note that the invention is not limited to the above-described embodiment, and it is needless to mention that various improvements and modifications can be made thereon within the range not departing from the spirit of the invention.

For example, in the above-described embodiment, the detecting module 205 is configured to store the audio signals of all the metering points mp0 to mp4 when the abnormality of audio signal is detected, but the present invention is not limited to this. The detecting module 205 may be configured to store only the audio signal of a particular metering point mp0 to mp4. For example, the detecting module 205 may be modified to set the metering point where the abnormality of audio signal occurred as a starting point, and store the audio signals of metering points located upstream (supply side of audio signals) of the metering point being the starting point on the signal processing path.

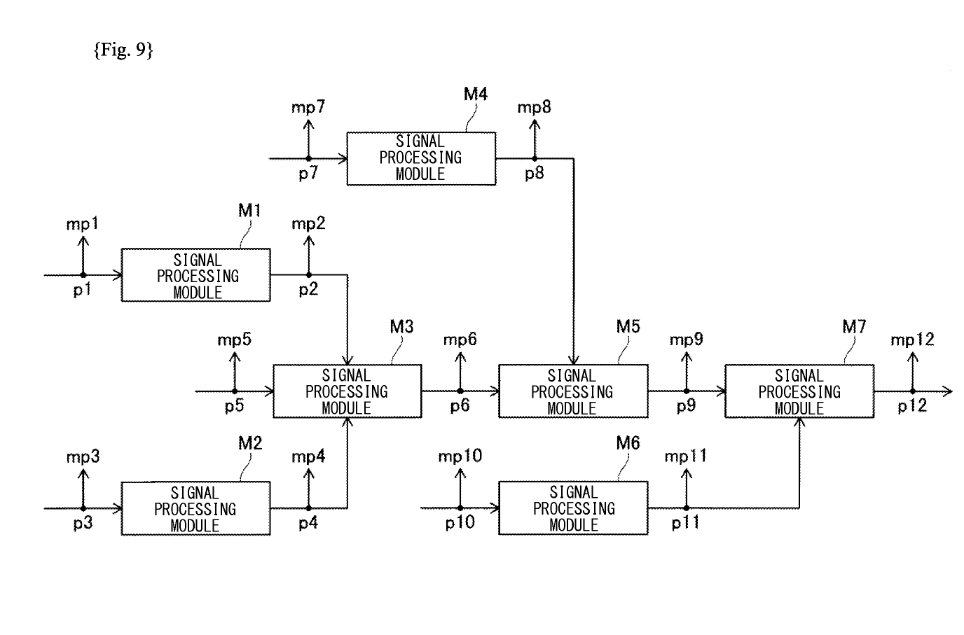

FIG. 9 is a block diagram illustrating signal transmission paths of plural signal processing modules (hereinafter referred to as “modules”) M1 to M7, in which metering points mp1 to mp12 are set, for explaining an embodiment to which this modification is added. The module M3 illustrated in FIG. 9 inputs audio signals outputted by two modules M1 and M2, performs processing such as mixing together with an audio signal inputted from the metering point mp5 and outputs the processed signal to the module M5. Further, the module M5 inputs outputs of the modules M3 and M4, performs processing such as mixing and outputs the processed signal to the module M7. Further, the module M7 inputs outputs of the modules M5 and M6, and processes them by performing processing such as mixing. To respective input and output ends of the modules M1 to M7, the metering points mp1 to mp12 are set as illustrated.

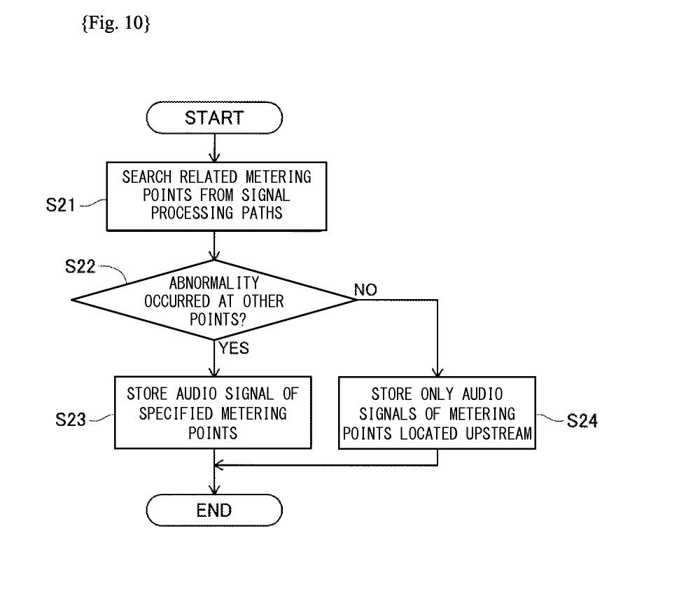

FIG. 10 is a flowchart illustrating processing of the detecting module 205 related to this modification. The detecting module 205 executes the flowchart of FIG. 10 in, for example, step S6 of the flowchart illustrated in FIG. 7. Operation of this embodiment will be described taking an example of the case where the abnormality of audio signal is detected at the metering point mp9 in the block diagram of FIG. 9. First, in step S21, the detecting module 205 sets the metering point mp9, where the abnormality of audio signal occurred, as the metering point being a starting point, and executes processing of searching the signal processing paths for metering points located upstream on the signal processing paths relative to the metering point mp9 (in this case, the metering points mp1 to mp8). The search processing by the detecting module 205 can be executed using, for example, a directed graph indicating a direction in which an audio signal is transmitted through the signal processing paths. The directed graph mentioned here represents, for example, a correlation of inputs and outputs of the metering points mp1 to mp12 illustrated in FIG. 9 by using an adjacency matrix or another representation method (adjacency list, or the like). Note that the detecting module 205 judges that a loop is formed in the signal processing path when the same metering points mp1 to mp12 are detected redundantly while the search processing is executed. When it is judged that a loop is formed in the signal processing path, for example, the metering point previous to the redundantly detected metering point is taken as an end, and the search is finished. Further, the search processing on the signal processing path is not limited to that using the directed graph, and another processing method (for example, processing using a spanning tree, or the like) can be used. Alternatively, the detecting module 205 may execute the process using a table or the like in which each metering point mp1 to mp12 is correlated in advance with an upstream metering points before reaching this metering point mp1 to mp12. In this case, the detecting module 205 can execute the search processing at a time of detecting the abnormality of audio signal quickly with a low processing load, by referring to the table corresponding to the metering point mp1 to mp12 where the abnormality of audio signal occurred.

Next, in step S22, the detecting module 205 judges whether the abnormality of audio signal has occurred or not at the upstream metering points mp1 to mp8 excluding the metering point mp9 being the starting point among the metering points mp1 to mp9 which are search results of step S21. When it is judged that the abnormality of audio signal has not occurred at the upstream metering points mp1 to mp8, the detecting module 205 performs setting to store the audio signal to each of the metering points mp1 to mp9 which are search results of step S21 (step S23). In this case, the audio signals of the metering points mp10 to mp12 are not stored, which are not included in the upstream signal processing paths with the metering point mp9 being the starting point.

Further, in step S22, when it is judged that the abnormality of audio signal has occurred at the other metering points mp1 to mp8 located upstream of the metering point mp9, the detecting module 205 performs setting to store the audio signal of the metering points located upstream of the most upstream metering point mp1 to mp9 among the plural metering points mp1 to mp9 where the abnormality of audio signal occurred (step S24). For example, when the abnormality of audio signal is detected also at the metering points mp2 and mp6 besides the metering point mp9, the detecting module 205 performs setting to store in the storage 113 only the audio signals of the most upstream metering point mp2 and the metering point mp1 located upstream thereof. In this case, the audio signals of the metering points mp3 to mp12 are not stored, which are not included in the path with the metering point mp2 being the starting point. Thus, in this embodiment, when the abnormality of audio signal is detected at plural metering points mp1 to mp12, the detecting module 205 stores the audio signals of the metering points upstream of the metering point being the starting point where the abnormality first occurred in the audio signal on the signal processing path. Further, when the abnormality of audio signal is detected at the metering points mp1 to mp8 on upstream different signal processing paths in step S22, the detecting module 205 takes the respective metering points as starting points to perform the processing. For example, when the abnormality is detected at each of the metering points mp2, mp4 and mp6 besides the metering point mp9, the detecting module 205 stores in the storage 113 the audio signals of the metering points mp1 and mp2 with the metering point mp2 being the starting point and the metering points mp3 and mp4 with the metering point mp4 being the starting point.

Note that the detecting module 205 may be configured to execute step S23 next to step S21 omitting the above-described processing of steps S22 and S24. In this case, the detecting module 205 does not perform the judgment processing of the most upstream metering point in step S22, and performs in next step S23 setting to store the audio signals of all the metering points included in the signal processing paths upstream of the metering point being the starting point of the search result in step S21.

Further, the signal processing paths constituted of the modules M1 to M7 are not limited to statically fixed paths, and the whole or part of the paths may be changed dynamically. For example, the signal processing paths are changed by the user by changing a setting to assign (patch) an input channel to an audio signal inputted via an input terminal of the audio I/F 111 (see FIG. 1). Alternatively, the signal processing paths are changed also when a module is added to the signal processing paths, for example when a selection of so-called wet and dry is switched depending on whether a module to add an effect (insertion effect) is inserted or not. Alternatively, the signal processing paths are changed when, for example, modules (modules M1 to M7 or the like) executed in the DSP 112 are reloaded and the modules are rearranged so as to change the configuration of the mixer. Thus, when the signal processing paths are changeable, the detecting module 205 is preferably configured so that information (elements of adjacency matrix of the directed graph, or the like) used for the search for a path is updated according to that the signal processing paths have been changed. Further, since the signal processing paths are changed appropriately, the detecting module 205 is preferably configured to correlate data of an audio signal to be stored with the state of signal processing paths (connecting relation of the modules M1 to M7) at a moment that the abnormality is detected, and store them in the storage 113. For example, the detecting module 205 stores, in the header area 501 of the data 500 (see FIG. 8) of the respective metering points mp1 to mp12, identification information of the modules M1 to M7 located upstream of the metering point.

Further, similarly to the previous embodiment, the detecting module 205 may be configured to temporarily store in the storage 113 the audio signals of all the metering points mp1 to mp12, minutely examine necessary data later, and store audio signals at upstream of the metering point, where the abnormality of audio signal is detected, being a starting point. Alternatively, the detecting module 205 may be configured to store audio signals of metering points mp1 to mp12 located upstream by a predetermined number of metering points (for example, up to four, or the like) from the metering point mp1 to mp12 where the abnormality of audio signal occurred, while taking the upstream metering points mp1 to mp12 as specific metering points. This predetermined number of metering points may be set based on the type of abnormality (clip, howl, or the like), which possibly occurs at the metering points mp1 to mp12, based on the respective processing in the modules M1 to M7.

In the embodiment to which this modification is added, when large-scale signal processing paths are provided in which numerous signal processing modules M1 to M7 are disposed, the amount of data stored in the storage 113 can be reduced as compared to the case where the audio signals of all the metering points mp1 to mp12 are stored. Further, reduction of the amount of data to be stored alleviates loads of the processing to store audio signals as a file in the storage 113 and various kinds of processing in the output module 206 referring to the stored file.

Further, in the above-described embodiment, the detecting module 205 is executed by the DSP 112, but it may be configured to execute part or whole of the detecting module 205 by the CPU 114. In this case, by executing the detecting module 205 by the CPU 114 as a processor different from the DSP 112, the load of processing on the DSP 112 can be alleviated.

Further, it may be configured to execute both the modules 201 to 203 and the detecting module 205 by the CPU 114. In this case, it may be configured such that the DSP 112 is omitted.

Further, the CPU 114 may be configured to have, for example, part or all of memories like those provided in the storage 113.

Further, part or all of functions which the audio I/F 111 and other devices have may be realized by the CPU 114.

Further, in the above-described embodiment, the audio signals before and after the abnormality of audio signal is detected are stored together, but it may be configured to store only an audio signal in the period in which the abnormality is detected in the audio signal. In this case, it may be configured such that the buffer used by the detecting module 205 is only the audio buffer 211, and the retention buffer 212 is omitted.

Further, the detecting module 205 stores audio signals in the period in which the abnormality of audio signal is detected, but it may be configured to store only an audio signal in a predetermined fixed time since the abnormality of audio signal is detected.

Further, the detecting module 205 may perform compression processing or the like to reduce the amount of data to be stored in the storage 113.

Further, the audio signal processing device 100 may be configured to output the audio signals stored in the storage 113 to an output device (for example, a headphone) other than the audio device 101.

Further, the audio device 101 may have a unit which inputs and outputs a digital audio signal.

Further, the audio device 101 may be configured to have the input unit and the output unit as respective individual devices.

Further, the connection between the audio device 101 and the audio signal processing device 100 is not limited to the coaxial cable, and another connection which can transmit audio signals, for example a LAN such as Ethernet (registered trademark) may be used.

Further, the displays (FIG. 4 and FIG. 5) on the display unit 117 are examples and may be changed appropriately. For example, the screen illustrated in FIG. 4 may be configured to display the metering points mp0 to mp4 by input channel.

Further, the output module 206 may display information related to the metering points mp0 to mp4 and the modules 201 to 203 where the clip is detected. For example, the output module 206 may display the frequency of occurrence of clip at the metering points mp0 to mp4 as a graph based on the storage start time and the number of detections in the header area 501 (see FIG. 8). Such a configuration enables the user to check a tendency of occurrence of the clip, or the like. For example, the user can early recognize a sign of failure of the device accompanying aging of the audio signal processing device 100, enabling the user to obviate occurrence of system failure. Note that in this case, the above-described statistic information may be individually displayed or outputted separately from the screen illustrated in FIG. 5.

Further, it may be configured to be able to reproduce the audio signal in which the abnormality is detected. For example, the CPU 114 may reproduce the state where the clip is detected by executing the output module 206, sequentially reading data of the metering points mp0 to mp4 specified by the user from data of the storage 113, and supplying the read data to the corresponding metering points mp0 to mp4, respectively. In this case, the CPU 114 may execute mute processing at a predetermined point by controlling supply of data of audio signals to the metering points mp0 to mp4. Further, it may be configured to store control parameters (for example, gain, cut-off frequency of filter, and the like) at the modules 201 to 203 together with the audio signals, and reproduce setting states of the control parameters together.

Further, it is needless to mention that the audio signal processing device 100 has a device to delete data stored in the storage 113 automatically or manually by the user, or the like.

Further, the switch button 305 is activated only when the clip is detected, but it may be constantly selectable.

Further, the audio signal processing device 100 may be configured to output stored audio signals to an external storage medium, a network, or the like. Such a configuration enables minutely analyzing the audio signal in which the clip is detected with a high-function terminal, or uploading it to a website of the manufacturer to ask for professional instructions, or the like. In this case, data of the detected audio signals may be stored directly in an external storage medium, or the like.

Further, in the above-described embodiment, the clip is detected and the audio signals are stored with respect to the metering points mp0 to mp4, but a configuration to detect and store the audio signal of at least one metering point will suffice. For example, it may be configured to detect and store only the metering point mp0 corresponding to an external signal source.

Further, the audio signal processing device 100 may automatically display on the display unit 117 a characteristic setting screen of a rotary encoder, a fader, and the like for setting parameters related to the relevant signal processing module when the clip is detected.

Further, the device in the present application is not limited to a device of stand-alone type which operates independently, and includes, for example, a group of devices (cloud computing, or the like) such as plural devices (virtual machines, and the like) cooperating via a network to process audio signals. Further, the device in the present application also includes a device such that plural virtual machines operate in one stand-alone type device, for example a device in which plural virtual machines (hosts) are executed in one piece of hardware to transmit audio signals to and receive audio signals from each other and process them.

### REFERENCE SIGNS LIST

100 . . . audio signal processing device
111 . . . audio interface
113 . . . storage
117 . . . display unit (display)
201 to 203 . . . first to third signal processing modules (signal processor)
205 . . . signal abnormality detecting module (signal abnormality detector)
206 . . . output module (outputter)
415 . . . button (selector)
mp0 to mp12 . . . metering points (measuring points)
M1 to M7 . . . signal processing modules (signal processor)

1. An audio signal processing device, comprising:
a signal processor configured to perform signal processing on an audio signal;
a signal abnormality detector configured to detect an abnormality of the audio signal at measuring points set with respect to the signal processor, and store in a storage the audio signal in which the abnormality is detected while correlating with the measuring points; and
an outputter configured to output the audio signal correlated with the measuring points and stored in the storage.

2. The audio signal processing device according to claim 1,
wherein the signal abnormality detector stores in the storage, together with the audio signal in which the abnormality is detected, at least one of the audio signal before the abnormality is detected and the audio signal after the abnormality is no longer detected.

3. The audio signal processing device according to claim 1,
wherein the signal abnormality detector stores, in the storage, also information related to the signal processor to which the measuring point where the abnormality of audio signal is detected is set, and
wherein the outputter outputs the information together with the stored audio signal or individually.

4. The audio signal processing device according to claim 1, comprising:
a display controller configured to control a display to display information indicating plural audio signals stored corresponding to the measuring points; and
a selector configured to select the audio signal to be outputted by the outputter from among the displayed audio signals.

5. The audio signal processing device according to claim 1,
wherein when the abnormality of audio signal is detected, the signal abnormality detector stores in the storage the audio signals at all the measuring points including the measuring point where the abnormality of audio signal is detected.

6. The audio signal processing device according to claim 1,
wherein when the abnormality of audio signal is detected, the signal abnormality detector stores in the storage the audio signals at the measuring point where the abnormality of audio signal is detected and at the measuring point located upstream of the measuring point where the abnormality of audio signal is detected along a signal processing path through which the audio signal is transmitted, among the measuring points.

7. A non-transitory machine-readable storage medium containing a program to be applied to an audio signal processing device processing an audio signal, the program enabling the device to execute:
detecting an abnormality of the audio signal at measuring points set with respect to a signal processor performing signal processing on the audio signal, and storing in a storage the audio signal in which the abnormality is detected while correlating with the measuring points; and
outputting the audio signal correlated with the measuring points and stored in the storage.

8. An audio signal processing method, comprising:
detecting an abnormality of the audio signal at measuring points set with respect to a signal processor performing signal processing on the audio signal; and
storing in a storage the audio signal in which the abnormality is detected while correlating with the measuring points.

9. The audio signal processing method according to claim 8,
wherein in the storing, the audio signals at all the measuring points including the measuring point where the abnormality of audio signal is detected are stored in the storage.

10. The audio signal processing method according to claim 8,
wherein in the storing, the audio signals at the measuring point where the abnormality of audio signal is detected and at the measuring point located upstream of the measuring point where the abnormality of audio signal is detected along a signal processing path through which the audio signal is transmitted, among the measuring points, are stored in the storage.
